(19) United States
(12) Patent Application Publication
(10) Pub. No.: US 2009/0018254 A1
(43) Pub. Date: Jan. 15, 2009

(54) AQUEOUS MULTICOMPONENT SYSTEMS, THEIR PREPARATION AND USE

(75) Inventors: Inge Huster, Munster (DE); Bernhard Lettmann, Drensteinfurt (DE); Egbert Nienhaus, Ascheberg (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/162,663

(22) PCT Filed: Feb. 8, 2007
(86) PCT No.: PCT/EP07/01070

§ 371 Date: Jul. 30, 2008

(30) Foreign Application Priority Data
Feb. 10, 2006 (DE) 102006006100.4

(51) Int. Cl. C08L 75/04; C08L 33/10

(52) U.S. Cl. 524/507

(57) ABSTRACT

Disclosed herein is an aqueous multicomponent system comprising (I) at least one aqueous binder component comprising (A) at least one secondary dispersion comprising (A1) at least one water-soluble or water-dispersible (meth)acrylate copolymer which can be prepared by a multistage copolymerization and has at least two isocyanate-reactive functional groups, and (A2) at least one low molecular weight or oligomeric, or at least one low molecular weight and oligomeric, substantially unbranched, hydrophobic polyester having at least two hydroxyl groups in the molecule, an OH number of 56 to 500 mg KOH/g, an acid number less than 10 mg KOH/g, and a number-average molecular weight Mn of 300 to 2000 Daltons, the at least one aqueous binder further comprising (B) at least one additive. The aqueous multicomponent system further comprises at least one water-free crosslinking component comprising at least one hydrophilicized polyisocyanate. Also disclosed is a process for preparing the foregoing aqueous multicomponent system.

### FIELD OF THE INVENTION

The present invention relates to new aqueous multicomponent systems. The present invention also relates to a new process for preparing aqueous multicomponent systems. The present invention relates not least to the use of the new aqueous multicomponent systems and of the aqueous multicomponent systems prepared by the new process to produce new aqueous curable materials.

### PRIOR ART

German patent application DE 199 14 899 A1 discloses multicomponent systems which serve to produce aqueous curable materials, especially aqueous coating materials.

The known multicomponent systems comprise a nonaqueous binder component (I) which comprises as binder a (meth)acrylate copolymer having isocyanate-reactive functional groups and prepared by a multistage copolymerization process, and a low molecular weight and/or oligomeric, substantially unbranched, hydrophobic polyester.

The known multicomponent systems further comprise a nonaqueous crosslinking component (II) which can comprise hydrophilicized polyisocyanates.

The known multicomponent systems additionally comprise an aqueous component (III) which can comprise at least one water-soluble or water-dispersible binder selected from the group consisting of (meth)acrylate copolymers, polyester resins, and polyurethanes.

The aqueous coating materials, especially clearcoat materials, prepared from the known multicomponent systems are homogeneous and stable. They give coatings, especially clearcoats, which exhibit high gloss, low haze, very good leveling, a very good appearance, and a high popping limit.

Nevertheless, when preparing the aqueous coating materials from the known multicomponent systems it is still always necessary to use devices such as stirrers in order to obtain homogeneous mixing rapidly. In the operation of a paintshop, especially a paintshop for automotive refinish, however, it is necessary that the aqueous coating materials can be prepared rapidly and reliably, homogeneously, by manual mixing, and even in small quantities.

### PROBLEM

The problem addressed by the present invention is that of providing new aqueous multicomponent systems which can be prepared easily and with very good reproduciblility.

The new aqueous multicomponent systems ought to make it possible to prepare new aqueous curable materials, preferably aqueous materials curable thermally or both thermally and with actinic radiation, especially aqueous coating materials, adhesives, sealants and precursors for moldings and sheets, curable thermally or both thermally and with actinic radiation, with rapidity and simplicity by means of manual mixing.

The new aqueous curable materials, preferably the new aqueous materials curable thermally or both thermally and with actinic radiation, especially the new aqueous coating materials, adhesives, sealants and precursors for moldings and sheets, curable thermally or both thermally and with actinic radiation, ought to give new cured thermoset materials, preferably new thermoset materials cured thermally or both thermally and with actinic radiation, and especially new coatings, adhesive layers, seals, moldings, and sheets cured thermally or both thermally and with actinic radiation, that have at least the same advantageous profile of properties as the cured thermoset materials of the prior art, if not indeed exceeding said profile of properties.

### SOLUTION PROVIDED BY THE INVENTION

Found accordingly have been the new aqueous multicomponent systems comprising

(I) at least one aqueous binder component comprising

(A) at least one secondary dispersion comprising
(A1) at least one water-soluble or water-dispersible (meth)acrylate copolymer which can be prepared by a multistage copolymerization and has at least two isocyanate-reactive functional groups, and
(A2) at least one low molecular weight and/or oligomeric, substantially unbranched, hydrophobic polyester having at least two hydroxyl groups in the molecule, an OH number of 56 to 500 mg KOH/g, an acid number <10 mg KOH/g, and a number-average molecular weight Mn of 300 to 2000 daltons; and

(B) at least one additive; and also

(II) at least one water-free crosslinking component comprising

(C) at least one hydrophilicized polyisocyanate.

The new aqueous multicomponent systems are referred to below as “systems of the invention”.

Additionally found has been the new process for preparing the systems of the invention, which involves
(1) preparing the binder component(s) (I) by dispersing in water at least one water-soluble or water-dispersible (meth)acrylate copolymer (A1) having at least two isocyanate-reactive functional groups and preparable by a multistage copolymerization, at least one low molecular weight and/or oligomeric, substantially unbranched, hydrophobic polyester (A2) having at least two hydroxyl groups in the molecule, an OH number of 56 to 500 mg KOH/g, an acid number <10 mg KOH/g, and a number-average molecular weight Mn of 300 to 2000 daltons, and at least one additive (B), and
(2) preparing the crosslinking component(s) (II) by mixing at least one hydrophilicized polyisocyanate (C) with at least one inert organic solvent (B) and homogenizing the resulting mixture, and then
(3) storing the binder component(s) (I) and the crosslinking component(s) (II) separately from one another until further use.

The new process for preparing the systems of the invention is referred to below as “process of the invention”.

Found not least has been the new use of the systems of the invention and of the systems of the invention obtained through the process of the invention for producing new curable materials, this being referred to below as “use in accordance with the invention”.

Additional subject matter of the invention will become apparent from the description.

### ADVANTAGES OF THE INVENTION

In the light of the prior art it was surprising and unforeseeable for the skilled worker that the object on which the present invention was based could be achieved by means of the systems of the invention, the process of the invention, and their use in accordance with the invention.

In particular it was surprising that the systems of the invention were prepared easily and with very good reproducibility by means in particular of the process of the invention.

The systems of the invention made it possible to produce new aqueous curable materials, preferably new aqueous materials curable thermally or both thermally and with actinic radiation, especially aqueous coating materials, adhesives, sealants, and precursors for moldings and sheets, curable thermally or both thermally and with actinic radiation, with rapidity and simplicity by means of manual mixing.

The aqueous curable materials of the invention, preferably the aqueous materials of the invention curable thermally or both thermally and with actinic radiation, and especially the aqueous coating materials, adhesives, sealants, and precursors of moldings and sheets of the invention, curable thermally or both thermally and with actinic radiation, gave new cured thermoset materials, preferably new thermoset materials cured thermally or both thermally and with actinic radiation, and especially new thermoset coatings, adhesive layers, seals, moldings, and sheets, cured thermally or both thermally and with actinic radiation, that have at least the same advantageous profile of properties as the cured thermoset materials of the prior art, if not indeed significantly exceeding said profile of properties.

### DETAILED DESCRIPTION OF THE INVENTION

The system of the invention is a multicomponent system, in particular a two-component system.

The system of the invention comprises at least one, especially one, aqueous binder component (I).

The aqueous binder component (I) comprises at least one, especially one, secondary dispersion (A).

The secondary dispersion (A) comprises at least one, especially one, water-soluble or water-dispersible (meth)acrylate copolymer (A1) having at least two isocyanate-reactive functional groups and preparable by a multistage, especially two-stage, copolymerization.

The isocyanate-reactive functional groups are preferably selected from the group consisting of hydroxyl groups, thiol groups, and primary and secondary amino groups. Hydroxyl groups in particular are used.

Examples of suitable water-soluble or water-dispersible (meth)acrylate copolymers (A1) preparable by multistage, especially two-stage, copolymerization, and also the appropriate processes for preparing them, are known in detail from
German patent application DE 199 14 899 A1, page 9, lines 22 to 25, in conjunction with page 9, line 50 to page 13, line 33, and
international patent application 1997/14731, hand-numbered page 4, lines 1 to 9 in conjunction with hand-numbered page 12, line 5, to hand-numbered page 22, line 33.

The amount of (meth)acrylate copolymer (A1) in the aqueous secondary dispersion (A) may vary very widely and can therefore be adapted outstandingly to the requirements of the case in hand. The amount of (A1), based in each case on (A), is preferably 10% to 60%, more preferably 15% to 55%, and in particular 20% to 50% by weight.

The aqueous secondary dispersion (A) further comprises at least one, especially one, low molecular weight and/or oligomeric, substantially unbranched, hydrophobic polyester (A2) having at least two, preferably four, and in particular three hydroxyl groups in the molecule, an OH number of 56 to 500, preferably 70 to 450, more preferably 80 to 400, and in particular 100 to 300 mg KOH/g, an acid number <10 and preferably <3 mg KOH/g, and a number-average molecular weight Mn of 300 to 2000 daltons.

The low molecular weight hydrophobic polyesters (A2) preferably have a number-average molecular weight of 300 to 1000 daltons, especially 300 to 700 daltons.

The oligomeric hydrophobic polyesters (A2) preferably have a number-average molecular weight of 400 to 2000 daltons, more preferably 450 to 1500 daltons, very preferably 600 to 1200 daltons, and in particular 450 to 1000 daltons.

Polyesters (A2) preferably have the general formula F1:

[R¹—CH(OH)—CH₂—OOC—]₂R (F1),

in which the variables have the following definitions:
R is substituted or unsubstituted divalent C₁ to C₂₀ alkanediyl, C₂ to C₂₀ alkenediyl, C₄ to C₂₀ cycloalkanediyl or cycloalkenediyl, C₆ to C₁₂ arylidene or divalent C₆ to C₂₀ arylalkyl, arylalkenyl, arylcycloalkyl, or arylcycloalkenyl radical; or
   substituted or unsubstituted divalent aliphatic, cycloaliphatic, acyclic or cyclic olefinically unsaturated, aromatic, aliphatic-aromatic, cycloaliphatic-aromatic, acyclically unsaturated-aromatic or cyclically unsaturated-aromatic radical which contains at least one carboxylic ester group;
R¹ is hydrogen atom or monovalent substituted or unsubstituted C₁ to C₂₀ alkyl, C₂ to C₂₀ alkenyl, C₄ to C₁₂ cycloalkyl or cycloalkenyl, C₆ to C₁₂ aryl or C₆ to C₂₀ arylalkyl, arylalkenyl, arylcycloalkyl, arylcycloalkenyl, alkylaryl, alkenylaryl, cycloalkylaryl, cycloalkenylaryl, alkylcycloalkyl, alkylcycloalkenyl, alkenylcycloalkyl, alkenylcycloalkenyl, cycloalkylalkyl, cycloalkenylalkyl, cycloalkylalkenyl or cycloalkenylalkenyl radical.

The radical R preferably contains at least one hydroxyl group.

The radical R¹ may be substituted by at least one substituent selected from the group consisting of —F, —Cl, —Br, —I, —CN, —NO₂, —OH, —OR², —SH, —SR², —NH₂, —NHR²—N(NR²)₂ and/or —OOC—R², in which the variable R² has the definition of the variables R¹ bar the hydrogen atom.

The radical R¹ is preferably a monosubstituted methyl group.

With particular preference the methyl group is monosubstituted by —OOC—R², in which the radical R² is a branched C₄ to C₁₂ alkyl radical.

Examples of suitable hydrophobic polyesters (A2) and also the processes for preparing them are known in detail from German patent application DE 199 14 899 A1, page 3, line 11, to page 8, line 32.

The amount of hydrophobic polyester (A2) in the aqueous secondary dispersion (A) may vary widely, and so may be adapted outstandingly to the requirements of the case in hand. The amount of (A2), based in each case on (A), is preferably 1% to 30%, more preferably 2% to 25%, and in particular 3% to 20% by weight.

In the aqueous secondary dispersion (A) the weight ratio of (meth)acrylate copolymer (A1) to hydrophobic polyester (A2) may vary widely and may therefore be adapted outstandingly to the requirements of the case in hand. The (A1):(A2) weight ratio is preferably 7:1 to 3:1, more preferably 6:1 to 3.5:1, and in particular 5.5:1 to 4:1.

The aqueous secondary dispersion (A) comprises at least one additive (B). Preferably it comprises at least two additives (B) and in particular at least three additives (B).

Preference is given to using additives (B) such as are customarily used in materials curable thermally or both thermally and with actinic radiation, preferably aqueous curable materials, more preferably aqueous coating materials, adhesives, sealants, and precursors for moldings and sheets, with very particular preference aqueous coating materials, particularly aqueous surfacers, basecoat materials, and clearcoat materials, and especially aqueous clearcoat materials.

For the purposes of the present invention actinic radiation is electromagnetic radiation such as near infrared (NIR), visible light, UV radiation, X-rays, and radiation, especially UV radiation, and particulate radiation such as electron beams, beta radiation, alpha radiation, proton beams, and neutron beams, especially electron beams.

The additive (B) or additives (B) is or are selected preferably from the group consisting of water-soluble and water-dispersible binders which are curable physically, thermally, with actinic radiation and thermally, and with actinic radiation and which are different from the binders (A1) described above, in particular polyurethanes; crosslinking agents which are different from the polyisocyanates (C) described below and react with the binders only at temperatures >100° C.; neutralizing agents; organic solvents, in particular water-miscible organic solvents; reactive diluents which are curable thermally, with actinic radiation and thermally, and with actinic radiation; transparent and opaque pigments, color pigments, effect pigments, and color and effect pigments; transparent and opaque fillers; nanoparticles; molecularly dispersely soluble dyes; light stabilizers; antioxidants; neutralizing agents; wetting agents; emulsifiers; slip additives; polymerization inhibitors; thermal crosslinking catalysts; thermolabile free-radical initiators; photoinitiators and photocoinitiators; adhesion promoters; flow control agents; film formation auxiliaries; rheological assistants; flame retardants; corrosion inhibitors; waxes; siccatives; biocides; and matting agents.

They are preferably used in the customary and known, effective amounts.

Examples of suitable additives (B) are known from German patent application DE 199 14 899 A1, page 14, line 36, to page 16, line 63, page 17, line 7, to page 18, line 13, page 18, lines 16 to 21, and page 19, lines 10 to 22 and 30 to 61.

A portion of the additives (B) may be present as at least one, especially one, separate adjuvant component (III) or in at least one, especially one, separate adjuvant component (III).

Preferably the additives (B) are present in the at least one, especially one, component (I) and, provided they do not reduce the storage stability of the below-described component (II) as a result of unwanted reactions, in component (II) as well. The additives (B) which may be present in component (II) are preferably inert, and in particular water-miscible, organic solvents (B).

The composition of component (I) may vary widely and so may be adapted outstandingly to the requirements of the case in hand.

The solids content of component (I) is preferably 10% to 70%, more preferably 15% to 65%, very preferably 20% to 60%, and in particular 25% to 55% by weight, based in each case on (I).

Solids content here and below means the sum of all constituents of a component or of a curable material that make up or help to make up, the solid substance of the cured thermoset material.

Component (I) preferably contains, based in each case on (I), 20% to 90%, more preferably 25% to 85%, very preferably 30% to 80%, and in particular 35% to 75% by weight of the aqueous secondary dispersion (A).

Component (I) preferably contains, based in each case on (I), 10% to 80%, more preferably 15% to 75%, very preferably 20% to 70%, and in particular 25% to 65% by weight of additives (B).

As part of the process of the invention the preparation of component (I) takes place preferably by mixing of the above-described constituents (A) and (B) and homogenization of the resulting mixture by means of suitable mixing equipment such as stirred tanks, inline dissolvers, rotor/stator dispersers, Ultraturrax devices, microfluidizers, high-pressure homogenizers or nozzle jet dispersers.

The system of the invention further comprises at least one, especially one, water-free crosslinking component (II).

The crosslinking component (II) comprises at least one, especially one, hydrophilicized polyisocyanate (C).

The hydrophilicized polyisocyanate (C) may have been hydrophilicized by means of nonionic hydrophilic groups, especially polyoxyalkylene groups, or by means of ionic hydrophilic groups, preferably acid groups, especially sulfonic acid groups. Preference is given in accordance with the invention to hydrophilicization by means of ionic groups, especially sulfonic acid groups.

Examples of suitable polyisocyanates which can be hydrophilicized by means of the above nonionic or ionic groups and thus form the hydrophilicized polyisocyanates (C) are known from German patent application DE 199 14 899 A1, page 18, line 40, to page 19, line 9.

Hydrophilicized aliphatic polyisocyanates (C) in particular are used.

The amount of the hydrophilicized polyisocyanate (C) in the crosslinking component (II) may vary widely and so may be adapted outstandingly to the requirements of the case in hand. The amount of hydrophilicized polyisocyanate (C) in the crosslinking component (II), based in each case on (II), is preferably 5% to 90%, more preferably 10% to 80%, very preferably 12% to 70%, and in particular 15% to 60% by weight.

The crosslinking component (II) preferably further comprises at least one, especially one, nonhydrophilicized, especially hydrophobic, polyisocyanate (D). Examples of suitable polyisocyanates (D) are known from German patent application DE 199 14 899 A1, page 18, line 40, to page 19, line 9. Also suitable are polyisocyanates which in addition to the free isocyanate groups also contain groups which can be activated with actinic radiation. Examples of suitable polyisocyanates (D) are known from European patent application EP 0 928 800 A1 or German patent application DE 101 29 970 A1.

In accordance with the invention it is preferred for the hydrophilicized polyisocyanates (C) and the polyisocyanates (D) to have the same parent structure.

The amount of nonhydrophilicized polyisocyanate (D) in the crosslinking component (II) may likewise vary widely and so may be adapted to the requirements of the case in hand. The crosslinking component (II) preferably contains, based in each case on (II), 10% to 95%, more preferably 20% to 90%, very preferably 30% to 90%, and in particular 40% to 85% by weight of nonhydrophilicized polyisocyanate (D).

The crosslinking component (II) preferably further comprises at least one inert organic solvent (B), i.e., an organic solvent containing no isocyanate-reactive functional groups.

The amount of organic solvents (B) in the crosslinking component (II) may vary very widely and so may be adapted outstandingly to the requirements of the case in hand. In general the amount of organic solvents (B) added is only such that the crosslinking component (II) has a viscosity which is advantageously low for mixing by hand (manual mixing). Preferably the crosslinking component (II) contains the organic solvents (B) in an amount of 5% to 50%, more preferably 10% to 45%, and in particular 15% to 40% by weight, based in each case on (II).

The preparation of the crosslinking component (II) as part of the process of the invention takes place by mixing of its above-described constituents (C) and (B) and also, where appropriate, (D) and homogenization of the resulting mixture, for which the mixing equipment described above may be employed.

The resulting components (I) and (II) of the system of the invention, and also any further components (III), such as adjuvant components (III), for example, are stored separately from one another until their use in accordance with the invention. If components (I) and (II) and also, where appropriate, (III) include constituents which can be activated with actinic radiation, the components in question are stored in the absence of actinic radiation.

In the context of their use in accordance with the invention the systems of the invention serve to prepare new aqueous curable materials, which are referred to below as “materials of the invention”.

To prepare a material of the invention at least one, especially one, binder component (I) and at least one, especially one, crosslinking component (II) and also, where appropriate, an adjuvant component (III) are mixed with one another, in the absence of actinic radiation where appropriate, and the resulting mixture is homogenized. In this context it proves to be a very particular advantage of the system of the invention that its components (I) and (II) and also, where appropriate, (III) can be mixed with one another easily and rapidly by hand and the resulting mixture can be homogenized easily and rapidly by hand.

For use in accordance with the invention, the weight ratio of component (I) to component (II) may vary widely and so may be adapted outstandingly to the requirements of the case in hand. The (I):(II) weight ratio is preferably set such that the equivalent ratio of isocyanate-reactive functional groups in (I) to the isocyanate groups in (II) is 2:1 to 1:3, more preferably 1.5:1 to 1:2.5, very preferably 1.2:1 to 1:2, and in particular 1.1:1 to 1:1.7.

The materials of the invention are preferably used as new aqueous coating materials, adhesives, sealants, and precursors for moldings and sheets, these materials being curable thermally or both thermally and with actinic radiation.

They are preferably used as coating materials of the invention.

With particular preference the coating materials of the invention are new aqueous primers, surfacers, basecoat, solid-color topcoat, and clearcoat materials, especially clearcoat materials, that are curable thermally or both thermally and with actinic radiation.

The materials of the invention serve in the context of their use in accordance with the invention to produce the thermoset materials of the invention.

The thermoset materials of the invention are preferably new coatings, adhesive layers, seals, moldings, and sheets, especially new coatings.

The coatings of the invention are preferably new primer coatings, surfacer coatings or antistonechip primers, basecoats, solid-color topcoats, and clearcoats, especially clearcoats.

These coatings of the invention may be single-coat or multicoat systems. With very particular preference they are multicoat systems and in that case may comprise at least two coatings, in particular at least one electrocoat, at least one surfacer coat or antistonechip primer coat, and also at least one basecoat and at least one clearcoat, or at least one solid-color topcoat.

With particular preference the multicoat paint systems of the invention comprise at least one basecoat and at least one clearcoat.

It is of particular advantage to produce the clearcoats of the multicoat paint systems of the invention from the clearcoat materials of the invention.

The clearcoats of the invention constitute the outermost coat of the multicoat paint systems of the invention, which is an important determinant of the overall appearance and which protects the color and/or effect basecoats from mechanical, chemical, and radiation-induced damage. The clearcoats of the invention prove in this context
to be particularly insensitive to mechanical stress such as tension, elongation, impact, scratching or abrasion,
to be particularly resistant to moisture (in the form of water vapor, for example), solvents, and dilute chemicals, and
to be particularly stable in the face of environmental influences such as temperature fluctuations and UV radiation, and
to have a high gloss and
to adhere well to a very wide variety of substrates.

Not least they exhibit no yellowing following their production.

Depending on the intended use, the materials of the invention are applied to temporary or permanent substrates.

For producing sheets and moldings of the invention it is preferred to use customary and known temporary substrates, such as metallic and polymeric belts or hollow bodies made of metal, glass, plastic, wood or ceramic, which are easily removable without damaging the sheets and moldings of the invention.

Where the mixtures of the invention are used for producing coatings, adhesives, and seals, the substrates employed are permanent substrates.

The substrates are preferably
means of land, water or air transport which are operated by muscle power, hot air or wind, such as cycles, railroad trolleys, rowboats, sailboats, hot air balloons, gas balloons or sailplanes, and also parts thereof,
motorized means of land, water or air transport, such as motorcycles, utility vehicles or motor vehicles, especially automobiles, water going or underwater craft or aircraft, and also parts thereof,
stationary floating structures, such as buoys or parts of harbor installations,
the interior and exterior of buildings,
doors, windows, and furniture, and
hollow glassware,
small industrial components, such as nuts, bolts, edge caps or wheel rims,
containers, such as coils, freight containers or packaging,
electrical components, such as electronic windings, coils for example,
optical components,
mechanical components, and
white goods, such as household appliances, boilers and radiators.

The sheets and moldings of the invention may likewise serve as substrates.

In particular the substrates are automobile bodies and parts thereof. In this context the materials of the invention or the coatings of the invention produced from them serve preferably for the OEM finishing of the automobile bodies or for the refinishing of inventive and noninventive OEM finishes. The OEM finishes of the invention, especially those which include a clearcoat of the invention, enjoy outstanding overcoatability. The refinishes of the invention adhere outstandingly to the inventive and to noninventive OEM finishes.

In terms of method the application of the materials of the invention has no peculiarities but may instead take place by all customary and known application methods that are suitable for the mixture in question, such as, for example, by electrocoating, injecting, spraying, knifecoating, spreading, pouring, dipping, trickling or rolling. Preference is given to employing spray application methods.

During application it is advisable to operate in the absence of actinic radiation if the materials of the invention are additionally curable with actinic radiation.

For producing the multicoat paint systems of the invention it is possible to employ wet-on-wet methods and coating systems of the kind known for example from German patent applications DE 199 30 067 A 1, page 15, line 23, to page 16, line 36, or DE 199 40 855 A1, column 30, line 39, to column 31, line 48, and column 32, lines 15 to 29. It is a very significant advantage of use in accordance with the invention that basically all of the coats of the multicoat paint systems of the invention can be produced from the mixtures of the invention.

The thermal curing of the materials of the invention takes place or even begins in general at room temperature.

Where curing is to be accelerated by heating it is advisable to observe a rest time or flashoff time. The flashoff or rest time may have a duration of 30 s to 2 h, preferably 1 min to 1 h, and in particular 1 to 45 min. The rest time serves, for example, for the applied materials of the invention to flow out and undergo degassing, and for volatile constituents, such as any solvent present, to evaporate. Flashing off may be accelerated by an elevated temperature and/or a reduced atmospheric humidity.

The thermal curing of the applied materials of the invention may be accelerated, for example, by the action of a gaseous, liquid and/or solid, hot medium, such as hot air, heated oil or heated rolls, or by microwave radiation, infrared light and/or near infrared (NIR) light, preferably after a rest time or flashoff time. Heating takes place preferably in a forced-air oven or by irradiation using IR and/or NIR lamps.

Actinic radiation curing may be carried out by means of the customary and known apparatus and methods, as are described in, for example, German patent application DE 198 18 735 A 1, column 10, lines 31 to 61, German patent application DE 102 02 565 A1, page 9, paragraph [0092], to page 10, paragraph [0106], German patent application DE 103 16 890 A1, page 17, paragraphs [0128] to [0130], international patent application WO 94/11123, page 2, line 35, to page 3, line 6, page 3, lines 10 to 15, and page 8, lines 1 to 14, or the American patent U.S. Pat. No. 6,743,466 B2, column 6, line 53, to column 7, line 14.

The materials of the invention may also be cured in the substantial or complete absence of oxygen.

For the purposes of the present invention the oxygen is held to be substantially absent if the oxygen concentration at the surface of the applied mixtures of the invention is <21%, preferably <18%, more preferably <16%, very preferably 14%, with very particular preference 10%, and in particular <6% by volume.

For the purposes of the present invention the oxygen is held to be completely absent if the oxygen concentration at the surface is below the limit of the customary and known detection methods.

The oxygen concentration is preferably ≧0.001%, more preferably ≧0.01%, very preferably ≧0.1%, and in particular ≧0.5% by volume.

The desired oxygen concentrations can be set by means of the measures described in German patent DE 101 30 972 C1, page 6, paragraphs [0047] to [0052], or by the laying-on of films.

The resulting thermoset materials of the invention, preferably the sheets, moldings, coatings, adhesive layers, and seals of the invention, more preferably the coatings of the invention, very preferably the primer coatings, surfacer coatings or antistonechip primer coatings, basecoats, solid-color topcoats, and clearcoats of the invention, especially the clearcoats of the invention, are outstandingly suitable for coating, bonding, sealing, wrapping, and packaging the above-described primed or unprimed substrates and also for mounting on or installation in the above-described primed or unprimed substrates.

The resulting substrates of the invention which are coated with coatings of the invention, bonded with adhesive layers of the invention, sealed with seals of the invention and/or wrapped, packaged and/or joined using sheets and/or moldings of the invention have outstanding service properties in conjunction with a particularly long service life.

### EXAMPLES

### Preparation Example 1

### The Preparation of a Hydrophobic Polyester (A2)

A steel reactor was charged with 263 parts by weight of hexahydrophthalic anhydride and 114 parts by weight of trimethylolpropane and this initial charge was heated to 150° C. 423 parts by weight of Cardura® E10 (Versatic® acid glycidyl ester) were then metered into the resulting mixture over the course of an hour at a uniform rate. The resulting reaction mixture was heated at 150° C. until an acid number <3 mg KOH/g was reached. Subsequently the resulting hydrophobic polyester (A2) was cooled to 100° C. and diluted with methyl isobutyl ketone to a solids content of 80% by weight. The viscosity of the diluted system was 50 dpas (23° C.).

### Preparation Example 2

### The Preparation of an Aqueous Secondary Dispersion (A)

A steel reactor equipped with stirrer, reflux condenser, and two feed vessels was charged with 127.5 parts by weight of methyl isobutyl ketone and this initial charge was heated to 110° C. with stirring. At this temperature a monomer mixture of 25.3 parts by weight of styrene, 29.4 parts by weight of methyl methacrylate, 16.9 parts by weight of lauryl methacrylate, 38 parts by weight of hydroxyethyl methacrylate, and 33.7 parts by weight of butyl methacrylate was metered in at a uniform rate over three hours from the first feed vessel and, simultaneously, a solution of 8.7 parts by weight of tert-butyl peroxyethyl-hexanoate in 19.8 parts by weight of methyl isobutyl ketone was metered in at a uniform rate over three hours from the second feed vessel. This was followed by continued polymerization at 110° C. for one hour.

Thereafter, at this temperature and commencing simultaneously, a monomer mixture of 10.9 parts by weight of styrene, 12.6 parts by weight of methyl methacrylate, 7.2 parts by weight of lauryl methacrylate, 40.2 parts by weight of hydroxyethyl methacrylate, 14.5 parts by weight of butyl methacrylate, and 12.2 parts by weight of acrylic acid was metered in over 2.75 hours from the first feed vessel, and a solution of 5.8 parts by weight of tert-butyl peroxyethylhexanoate in 23 parts by weight of methyl isobutyl ketone was metered in over 3.5 hours from the second feed vessel. The resulting reaction mixture was polymerized at 110° C. for two hours, to give a solution of the methacrylate copolymer (A1).

Added to the solution of the methacrylate copolymer (A1) were 68.4 parts by weight of the solution of the hydrophobic polyester (A2) from Preparation Example 1, 6.7 parts by weight of dimethylethanolamine, and 11.5 parts by weight of triethanolamine. The resulting mixture was dispersed at 80° C. in 110 parts by weight of deionized water. The resulting dispersion was held at 80° C. for two hours. Subsequently 360 parts by weight of deionized water were added and the methyl isobutyl ketone was distilled off under reduced pressure.

The resulting secondary dispersion (A) was adjusted with deionized water to a solids of 40% by weight. It had a pH of 7.5 and an acid number of 39 mg KOH/g resin solids.

### Preparation Example 3

### The Preparation of an Aqueous Polyurethane Resin Dispersion (B)

A steel reactor was charged with 297.2 parts by weight of neopentyl glycol hydroxypivalate, 32.8 parts by weight of phthalic anhydride, 5.7 parts by weight of 2-butyl-2-ethylpropanediol-1,3, 133.5 parts by weight of neopentyl glycol, 346.4 parts by weight of isophthalic acid, and 11.2 parts by weight of cyclohexane (azeotrope former). The resulting mixture was heated with stirring, the water of condensation being removed continuously, until an acid number of 3.5 mg KOH/g was reached. The resulting polyester diol was cooled to 60° C. and diluted with methyl ethyl ketone to a solids content of 80% by weight.

A steel reactor suitable for polyurethane resin synthesis was charged with 264.7 parts by weight of the polyester diol solution, 2.3 parts by weight of 2-butyl-2-ethylpropane-1diol-3-, 24.4 parts by weight of dimethylolpropionic acid, and 112.4 parts by weight of m-tetra-methylxylylidene diisocyanate, and this initial charge was heated to 82° C. with stirring until a constant isocyanate content was reached. Subsequently 36.2 parts by weight of trimethylol-propane were added and the resulting reaction mixture was heated until isocyanate groups were no longer detectable. Following the addition of 44.5 parts by weight of methyl ethyl ketone the polyurethane resin (B) was neutralized with 13 parts by weight of dimethylethanolamine and dispersed at 60° C. in 480 parts by weight of deionized water. Subsequently the methyl ethyl ketone was distilled off under reduced pressure.

The resulting secondary polyurethane resin dispersion (B) was adjusted with deionized water to a solids content of 40% by weight. It had a pH of 7.2 and an acid number of 30 mg KOH/g resin solids.

### Example 1

### The Preparation of a Two-Component System

### 1.1 The Preparation of a Component (I)

Component (I) was prepared by mixing the following constituents in the stated order and by homogenizing the resulting mixture:
60 parts by weight of aqueous secondary dispersion (A) from Preparation Example 2,
25 parts by weight of polyurethane resin dispersion (B) from Preparation Example 3,
0.8 part by weight of a polyurethane-based thickener (B) (Dapral® 210T, 10 percent strength in deionized water),
2.5 parts by weight of butyl glycol acetate (B),
3.0 parts by weight of butyl glycol (B),
3.0 parts by weight of a wetting agent (B) (Deuterol® 201E),
0.3 part by weight of a flow control agent (B) based on a polyether-modified polydimethylsiloxane (Byk® 331),
0.2 part by weight of a flow control agent based on a siloxane-polyalkylene oxide copolymer (B) (Silwet® L 7604),
0.2 part by weight of a reversible free-radical scavenger (B) (HALS; Tinuvin® 292),
0.2 part by weight of a UV absorber (B) (Tinuvin® 384-2) and
4.8 parts by weight of deionized water.

The resulting component (I) was stable on storage and was transportable without problems.

### 1.2 The Preparation of a Component (II)

Component (II) was prepared by mixing the following constituents and homogenizing the resulting mixture:
32 parts by weight of a hydrophobic polyisocyanate (D) based on a hexamethylene diisocyanate trimer (Desmodur® XP2410),
38 parts by weight of a hydrophilicized polyisocyanate (C) based on a hexamethylene diisocyanate trimer (Bayhydur® XP2570) and
30 parts by weight of butyl glycol acetate (B).

The two-component system was fully stable on storage and was transportable without problems.

### Example 2

### The Preparation of an Aqueous Clearcoat Material

The aqueous clearcoat material was prepared by manual mixing of 100 parts by weight of component (I) from Example 1.1 with 29 parts by weight of component (II) from Example 1.2. The resulting aqueous clearcoat material was homogeneously mixed after just a short time. It was adjusted to spray viscosity by addition of 30 parts by weight of deionized water. It had a processing life of several hours, which is compatible with art practice.

### Example 3

### The Production of a Multicoat Effect Paint System

Phosphated steel panels coated with an electrocoat and a surfacer coat were coated with an aqueous metal-effect basecoat material in accordance with international patent application WO 1987/003829 to give a dry film thickness of 12 to 15 μm. The aqueous basecoat films were dried at room temperature for 5 minutes and at 60° C. for 10 minutes.

The clearcoat material of Example 2 was applied in two spray passes with a 4-minute flashoff time in between to the aqueous basecoat films, uniformly, so as to give a dry film thickness of 50 μm.

The popping limit was determined by applying the clearcoat material of Example 2 in wedge form to the aqueous basecoat films.

The resulting clearcoat films were flashed off at room temperature for 10 minutes and dried in a forced-air oven at 60° C. for 45 minutes.

The performance properties of the resulting multicoat paint systems, each comprising an electrocoat, a surfacer coat, a metallic basecoat, and a clearcoat, were as follows:

| | |
|---|---|
| Gloss (20°) to DIN 67530: | 87 units; |
| Haze (20°) to DIN 67530: | 11.4 units; |
| Overall visual appearance: | clear; |
| Basecoat wetting: | good; and |
| Popping limit: | 85 μm. |

1. An aqueous multicomponent system comprising
(I) at least one aqueous binder component comprising
(A) at least one secondary dispersion comprising
(A1) at least one water-soluble or water-dispersible (meth)acrylate copolymer which is prepared by a multistage copolymerization and has at least two isocyanate-reactive functional groups, and
(A2) at least one substantially unbranched, hydrophobic polyester, which is low molecular weight or oligomeric, or a combination of low molecular weight and oligomeric, and which has at least two hydroxyl groups in the molecule, an OH number of 56 to 500 mg KOH/g, an acid number less than 10 mg KOH/g, and a number-average molecular weight Mn of 300 to 2000 Daltons; and
(B) at least one additive; and
(II) at least one water-free crosslinking component comprising
(C) at least one hydrophilicized polyisocyanate comprising at least one acid group.

2. The aqueous multicomponent system of claim 1, wherein the at least two isocyanate-reactive functional groups of the (meth)acrylate copolymer (A1) are selected from the group consisting of hydroxyl groups, thiol groups, primary amino groups secondary amino groups, and combinations thereof.

3. The aqueous multicomponent system of claim 1, wherein the hydrophobic polyester (A2) has the general formula:
[R¹—CH(OH)—CH₂—OOC—]₂R,
wherein R is a substituted or unsubstituted divalent C₁ to C₂₀ alkanediyl, C₂ to C₂₀ alkenediyl, C₄ to C₂₀ cycloalkanediyl or cycloalkenediyl, C₆ to C₁₂ arylidene, divalent C₆ to C₂₀ arylalkyl, divalent C₆ to C₂₀ arylalkenyl, divalent C₆ to C₂₀ arylcycloalkyl, divalent C₆ to C₂₀ arylcycloalkenyl radical; or R is a substituted or unsubstituted divalent aliphatic, cycloaliphatic, acyclic olefinically unsaturated cyclic olefinically unsaturated, aromatic, aliphatic-aromatic, cycloaliphatic-aromatic, acyclically unsaturated-aromatic, or cyclically unsaturated-aromatic radical which contains at least one carboxylic ester group; R¹ is hydrogen atom or monovalent substituted or unsubstituted C₁ to C₂₀ alkyl, C₂ to C₂₀ alkenyl, C₄ to C₁₂ cycloalkyl, C₄ to C₁₂ cycloalkenyl, C₆ to C₁₂ aryl, C₆ to C₂₀ arylalkyl, C₆ to C₂₀ arylalkenyl, C₆ to C₂₀ arylcycloalkyl, C₆ to C₂₀ arylcycloalkenyl, C₆ to C₂₀ alkylaryl, C₆ to C₂₀ alkenylaryl, C₆ to C₂₀ cycloalkylaryl, C₆ to C₂₀ cycloalkenylaryl, C₆ to C₂₀ alkylcycloalkyl, C₆ to C₂₀ alkylcycloalkenyl, C₆ to C₂₀ alkenylcycloalkyl, C₆ to C₂₀ alkenylcycloalkenyl, C₆ to C₂₀ cycloalkylalkyl, 6 to C₂₀ cycloalkenylalkyl, C₆ to C₂₀ cycloalkylalkenyl or C₆ to C₂₀ cycloalkenylalkenyl radical.

4. The aqueous multicomponent system of claim 3, wherein the radical R contains at least one hydroxyl group.

5. The aqueous multicomponent system of claim 3, wherein the radical R¹ is substituted by at least one substituent selected from the group consisting of —F, —Cl, —Br, —I, —CN, —NO₂, —OH, —OR², —SH, —SR², —NH₂, —NHR², —N(NR²)₂ and —OOC—R², in which R² is defined by R¹ except for the hydrogen atom.

6. The aqueous multicomponent system of claim 3, wherein the radical R¹ is a monosubstituted methyl group.

7. The aqueous multicomponent system of claim 6, wherein the methyl group is monosubstituted by —OOC—R², in which the radical R² is a branched C₄ to C₁₂ alkyl radical.

8. The aqueous multicomponent system of claim 1, wherein the additive (B) is selected from the group consisting of water-soluble and water-dispersible binders which are physically curable, thermally curable, curable with actinic radiation and thermally curable, or curable with actinic radiation and which binders are different from the at least one water-soluble or water-dispersable (meth)acrylate copolymer (A1); crosslinking agents which are different from the polyisocyanates (C) and react with the at least one water-soluble or water-dispersable (meth)acrylate copolymer (A1) only at temperatures greater than 100° C.; neutralizing agents; organic solvents; reactive diluents which are thermally curable, curable with actinic radiation and thermally curable, or with actinic radiation; transparent and opaque pigments, color pigments, effect pigments, and color and effect pigments; transparent and opaque fillers; nanoparticles; molecularly dispersed soluble dyes; light stabilizers; antioxidants; neutralizing agents; wetting agents; emulsifiers; slip additives; polymerization inhibitors; thermal crosslinking catalysts; thermolabile free-radical initiators; photoinitiators, photocoinitiators; adhesion promoters; flow control agents; film formation auxiliaries; rheological assistants; flame retardants; corrosion inhibitors; waxes; siccatives; biocides; matting agents, and combinations comprising at least one of the foregoing additives.

9. The aqueous multicomponent system of claim 8, wherein the at least one water-soluble and water-dispersible (meth)acrylate copolymer which are physically curable, thermally curable, curable with actinic radiation and thermally curable, or curable with actinic radiation and which are different from the at least one water-soluble or water-dispersable (meth)acrylate copolymer (A1) are polyurethanes.

10. The aqueous multicomponent system of claim 1, wherein said at least one acid group of the at least one hydrophilicized polyisocyanate (C) is a sulfonic acid group.

11. The aqueous multicomponent system of claim 1, wherein the at least one crosslinking component (II) comprises at least one inert organic solvent.

12. The aqueous multicomponent system claim 1, wherein the at least one crosslinking component (II) comprises at least one hydrophobic polyisocyanate.

13. A process for preparing an aqueous multicomponent system, which comprises
(1) preparing at least one aqueous binder component (I) by dispersing in water: (A1) at least one water-soluble or water-dispersible (meth)acrylate copolymer having at least two isocyanate-reactive functional groups, prepared by a multistage copolymerization; (A2) at least one substantially unbranched, hydrophobic polyester, which is low molecular weight or oligomeric, or low molecular weight and oligomeric, and which has at least two hydroxyl groups in the molecule, an OH number of 56 to 500 mg KOH/g, an acid number less than 10 mg KOH/g, and a number-average molecular weight Mn of 300 to 2000 Daltons; and (B) at least one additive (B), and
(2) preparing at least one water-free crosslinking component (II) by mixing: (C) at least one hydrophilicized polyisocyanate which contains at least one acid group with at least one inert organic solvent and homogenizing the resulting mixture, and then
(3) storing the at least one aqueous binder component (I) and the at least one water-free crosslinking component (II) separately from one another until further use.

14. The process of claim 13, wherein for the preparation of the at least one water-free crosslinking component (II) additionally at least one hydrophobic polyisocyanate is added.

15. The process of claim 13 wherein the aqueous multicomponent system is an aqueous curable material.

16. The process of claim 15, wherein the aqueous curable material is thermally curable or both thermally curable and curable with actinic radiation.

17. The process of claim 16, wherein said actinic radiation is UV radiation, electron beam radiation, or both UV radiation and electron beam radiation.

18. The process of claim 15, wherein said aqueous curable material is used as an aqueous coating material, adhesive, sealant, or precursor for moldings or sheets.

19. The process of claim 18, wherein said aqueous coating material is used as a clearcoat material.

20. The process of claim 19, wherein said aqueous curable material is used as a cured thermoset material.

21. The process of claim 20, wherein said cured thermoset material is used as a coating, adhesive layer, seal, molding or sheet.

22. The process of claim 21, wherein said coating is used as a clearcoat.

23. The process of claim 22, wherein said clearcoat is used as a clearcoat as part of a multicoat color system, multicoat effect paint system, or combination thereof.

24. The process of claim 23, wherein said multicoat color system, multicoat effect paint system, or combination thereof, is produced by a wet-on-wet method.

25. The process of claim 20, wherein said cured thermoset material is used to coat, bond, seal, wrap or package a primed or unprimed substrate or is used for installation in or mounting on a primed or unprimed substrate.

26. The process of claim 25, wherein said substrate is an automobile body or part thereof.
